(19) United States
(12) Patent Application Publication
(10) Pub. No.: US 2020/0161760 A1
(43) Pub. Date: May 21, 2020

(54) APPARATUS AND METHODS FOR PHASE SHIFTING

(71) Applicant: Skyworks Solutions, Inc., Woburn, MA (US)

(72) Inventor: William J. Domino, Yorba Linda, CA (US)

(21) Appl. No.: 16/667,074

(22) Filed: Oct. 29, 2019

Related U.S. Application Data
(60) Provisional application No. 62/767,713, filed on Nov. 15, 2018.

(51) Int. Cl. H01Q 3/36; H04B 1/40; H01Q 1/24; H01Q 21/22

(52) U.S. Cl. CPC H01Q 3/36; H01Q 21/22; H01Q 1/246; H04B 1/40

(57) ABSTRACT

Apparatus and methods for phase shifting are provided herein. In certain embodiments, a phase shifter includes a group of positive phase shifting circuits, a group of negative phase shifting circuits, and a group of selection switches for controlling selection of the positive phase shifting circuits and the negative phase shifting circuits. The selection switches are formed on a semiconductor die, and are operable to connect one or more selected positive phase shifting circuits and/or one or more selected negative phase shifting circuits between an input terminal and an output terminal, thereby controlling an overall phase shift provided by the phase shifter.

### CROSS-REFERENCE TO RELATED APPLICATIONS

This application claims the benefit of priority under 35 U.S.C. § 119 of U.S. Provisional Patent Application No. 62/767,713, filed Nov. 15, 2018, and titled “APPARATUS AND METHODS FOR PHASE SHIFTING,” which is herein incorporated by reference in its entirety.

### BACKGROUND

### Technical Field

Embodiments of the invention relate to electronic systems, and in particular, to radio frequency (RF) electronics.

### Description of the Related Technology

Phase shifters are used in RF communication systems to control the phase of RF signals transmitted or received wirelessly via antennas.

Examples of RF communication systems with one or more phase shifters include, but are not limited to, mobile phones, tablets, base stations, network access points, customer-premises equipment (CPE), laptops, and wearable electronics. For example, in wireless devices that communicate using a cellular standard, a wireless local area network (WLAN) standard, and/or any other suitable communication standard, a power amplifier can be used for RF signal amplification. An RF signal can have a frequency in the range of about 30 kHz to 300 GHz, such as in the range of about 410 MHz to about 7.125 GHz for certain communications standards.

### SUMMARY

In certain embodiments, the present disclosure relates to a phase shifter for a communication system. The phase shifter includes an input terminal configured to receive a radio frequency input signal, an output terminal configured to provide a radio frequency output signal having a phase shift with respect to the radio frequency input signal, a plurality of positive phase shifting circuits, a plurality of negative phase shifting circuits, and a plurality of selection switches formed on a semiconductor die and configured to couple one or more selected phase shifting circuits between the input terminal and the output terminal, the one or more selected phase shifting circuits chosen from at least one of the plurality of positive phase shifting circuits or the plurality of negative phase shifting circuits.

In various embodiments, each of the plurality of negative phase shifting circuits provides a phase shift of about equal magnitude but opposite polarity as a corresponding one of the plurality of positive phase shifting circuits.

In several embodiments, the phase shifter further includes a plurality shunt switches configured to electrically connect one or more unselected phase shifting circuit to a reference voltage, the one or more unselected phase shifting circuits chosen from at least one of the plurality of positive phase shifting circuits or the plurality of negative phase shifting circuits.

In a number of embodiments, the plurality of positive phase shifting circuits includes a first plurality of inductor-capacitor networks, and the plurality of negative phase shifting circuits includes a second plurality of inductor-capacitor networks. According to some embodiments, the first plurality of inductor-capacitor networks are each implemented as a high pass filter, and the second plurality of inductor-capacitor networks are each implemented as a low pass filter. In accordance with various embodiments, the first plurality of inductor-capacitor networks and the second plurality of inductor-capacitor networks are each implemented in a tee configuration. According to several embodiments, the first plurality of inductor-capacitor networks and the second plurality of inductor-capacitor networks are each implemented in a pi configuration. In accordance with some embodiments, the first plurality of inductor-capacitor networks includes a plurality of series inductors and a plurality of shunt capacitors, and the second plurality of inductor-capacitor networks includes a plurality of series capacitors and a plurality of shunt inductors. According to various embodiments, the first plurality of inductor-capacitor networks includes a plurality of series capacitors and a plurality of shunt inductors, and the second plurality of inductor-capacitor networks includes a plurality of series inductors and a plurality of shunt capacitors.

In several embodiments, the phase shifter further includes a control circuit formed on the semiconductor die and configured to control the plurality of selection switches. According to various embodiments, the control circuit is configured to control the plurality of selection switches based on digital data received over an interface of the semiconductor die.

In a number of embodiments, at least a portion of the plurality of positive phase shifting circuits and at least a portion of the plurality of negative phase shifting circuits are formed on the semiconductor die.

In several embodiments, at least a portion of the plurality of positive phase shifting circuits and at least a portion of the plurality of negative phase shifting circuits are formed as surface mount components on a substrate to which the semiconductor die is attached.

In some embodiments, each of the plurality of positive phase shifting circuits provides a different amount of phase shift to the radio frequency input signal. In accordance with a number of embodiments, the plurality of positive phase shifting circuits are binary weighted.

In various embodiments, each of the plurality of negative phase shifting circuits provides a different amount of phase shift to the radio frequency input signal. According to several embodiments, the plurality of negative phase shifting circuits are binary weighted.

In certain embodiments, the present disclosure relates to a wireless device. The beamforming communication system includes an antenna array including a plurality of antenna elements, and a plurality of signal conditioning circuits each operatively associated with a corresponding one of the plurality of antenna elements and including a phase shifter, and a transceiver electrically coupled to the plurality of signal conditioning circuits. The phase shifter includes a plurality of positive phase shifting circuits, a plurality of negative phase shifting circuits, and a plurality of selection switches. The plurality of selection switches are formed on a semiconductor die and configured to couple one or more selected phase shifting circuits between an input and an output of the phase shifter, and the one or more selected phase shifting circuits chosen from at least one of the plurality of positive phase shifting circuits or the plurality of negative phase shifting circuits.

In various embodiments, each of the plurality of negative phase shifting circuits provides a phase shift of about equal magnitude but opposite polarity as a corresponding one of the plurality of positive phase shifting circuits.

In several embodiments, the phase shifter further includes a plurality shunt switches configured to electrically connect one or more unselected phase shifting circuit to a reference voltage, and the one or more unselected phase shifting circuits are chosen from at least one of the plurality of positive phase shifting circuits or the plurality of negative phase shifting circuits.

In a number of embodiments, the plurality of positive phase shifting circuits includes a first plurality of inductor-capacitor networks, and the plurality of negative phase shifting circuits includes a second plurality of inductor-capacitor networks. According to various embodiments, the first plurality of inductor-capacitor networks are each implemented as a high pass filter, and the second plurality of inductor-capacitor networks are each implemented as a low pass filter. In accordance with some embodiments, the first plurality of inductor-capacitor networks and the second plurality of inductor-capacitor networks are each implemented in a tee configuration. According to several embodiments, the first plurality of inductor-capacitor networks and the second plurality of inductor-capacitor networks are each implemented in a pi configuration. In accordance with various embodiments, the first plurality of inductor-capacitor networks includes a plurality of series inductors and a plurality of shunt capacitors, and the second plurality of inductor-capacitor networks includes a plurality of series capacitors and a plurality of shunt inductors. According to some embodiments, the first plurality of inductor-capacitor networks includes a plurality of series capacitors and a plurality of shunt inductors, and the second plurality of inductor-capacitor networks includes a plurality of series inductors and a plurality of shunt capacitors.

In various embodiments, the phase shifter further includes a control circuit formed on the semiconductor die and configured to control the plurality of selection switches. According to several embodiments, the control circuit is configured to control the plurality of selection switches based on digital data received over an interface of the semiconductor die.

In a number of embodiments, at least a portion of the plurality of positive phase shifting circuits and at least a portion of the plurality of negative phase shifting circuits are formed on the semiconductor die.

In some embodiments, at least a portion of the plurality of positive phase shifting circuits and at least a portion of the plurality of negative phase shifting circuits are formed as surface mount components on a substrate to which the semiconductor die is attached.

In various embodiments, each of the plurality of positive phase shifting circuits provides a different amount of phase shift to the radio frequency input signal. According to a number of embodiments, the plurality of positive phase shifting circuits are binary weighted.

In several embodiments, each of the plurality of negative phase shifting circuits provides a different amount of phase shift to the radio frequency input signal. In accordance with some embodiments, the plurality of negative phase shifting circuits are binary weighted.

In certain embodiments, the present disclosure relates to a method of phase shifting in a communication system. The method includes selecting one or more phase shifting circuits using a plurality of selection switches of a semiconductor die, the one or more selected phase shifting circuits chosen from a plurality of available phase shifting circuits that include a plurality of positive phase shifting circuits and a plurality of negative phase shifting circuits. The method further includes electrically connecting the one or more selected phase shifting circuits between an input terminal and an output terminal using the plurality of selection switches, receiving a radio frequency input signal at the input terminal, and generating a radio frequency output signal at the output terminal with a phase shift relative to the radio frequency input signal, the phase shift based on the one or more selected phase shifting circuits.

In some embodiments, the method further includes receiving digital data over an interface of the semiconductor die, and controlling the plurality of selection switches based on the digital data.

In a number of embodiments, the method further includes electrically connecting at least one unselected phase shifting circuit to a reference voltage, the at least one unselected phase shifting circuit chosen from the plurality of available phase shifting circuits.

In various embodiments, the method further includes providing a different amount of phase shift to the radio frequency input signal using each of the plurality of positive phase shifting circuits. According to several embodiments, the plurality of positive phase shifting circuits are binary weighted.

In some embodiments, the method further includes providing a different amount of phase shift to the radio frequency input signal using each of the plurality of negative phase shifting circuits. According to several embodiments, the plurality of positive phase shifting circuits are binary weighted.

In a number of embodiments, each of the plurality of negative phase shifting circuits provides a phase shift of about equal magnitude but opposite polarity as a corresponding one of the plurality of positive phase shifting circuits.

In several embodiments, the plurality of positive phase shifting circuits includes a first plurality of inductor-capacitor networks, and the plurality of negative phase shifting circuits includes a second plurality of inductor-capacitor networks. According to various embodiments, the first plurality of inductor-capacitor networks are each implemented as a high pass filter, and the second plurality of inductor-capacitor networks are each implemented as a low pass filter. In according with several embodiments, the first plurality of inductor-capacitor networks and the second plurality of inductor-capacitor networks are each implemented in a tee configuration. According with a number of embodiments, the first plurality of inductor-capacitor networks and the second plurality of inductor-capacitor networks are each implemented in a pi configuration. In according with several embodiments, the first plurality of inductor-capacitor networks includes a plurality of series inductors and a plurality of shunt capacitors, and the second plurality of inductor-capacitor networks includes a plurality of series capacitors and a plurality of shunt inductors. In accordance with various embodiments, the first plurality of inductor-capacitor networks includes a plurality of series capacitors and a plurality of shunt inductors, and the second plurality of inductor-capacitor networks includes a plurality of series inductors and a plurality of shunt capacitors.

In some embodiments, at least a portion of the plurality of positive phase shifting circuits and at least a portion of the plurality of negative phase shifting circuits are formed on the semiconductor die.

In various embodiments, at least a portion of the plurality of positive phase shifting circuits and at least a portion of the plurality of negative phase shifting circuits are formed as surface mount components on a substrate to which the semiconductor die is attached.

### BRIEF DESCRIPTION OF THE DRAWINGS

Embodiments of this disclosure will now be described, by way of non-limiting example, with reference to the accompanying drawings.

FIG. 1 is a schematic diagram of one example of a communication network.

FIG. 2A is a schematic diagram of one embodiment of a communication system that operates with beamforming.

FIG. 2B is a schematic diagram of one embodiment of beamforming to provide a transmit beam.

FIG. 2C is a schematic diagram of one embodiment of beamforming to provide a receive beam.

FIG. 3 is a schematic diagram of a phase shifter according to one embodiment.

FIG. 4 is a schematic diagram of a phase shifter according to another embodiment.

FIG. 5 is a schematic diagram of a phase shifter according to another embodiment.

FIG. 6A is a schematic diagram of a pair of phase shifting networks according to one embodiment.

FIG. 6B is a graph of one example of phase versus frequency for the pair of phase shifting networks of FIG. 6A.

FIG. 7 is a schematic diagram of a pair of phase shifting networks according to another embodiment.

FIG. 8 is a schematic diagram of one embodiment of a mobile device.

FIG. 9 is a plan view of one embodiment of a module.

FIG. 10A is a perspective view of another embodiment of a module.

FIG. 10B is a cross-section of the module of FIG. 10A taken along the lines 10B-10B.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and plans to introduce Phase 2 of 5G technology in Release 16 (targeted for 2019). Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

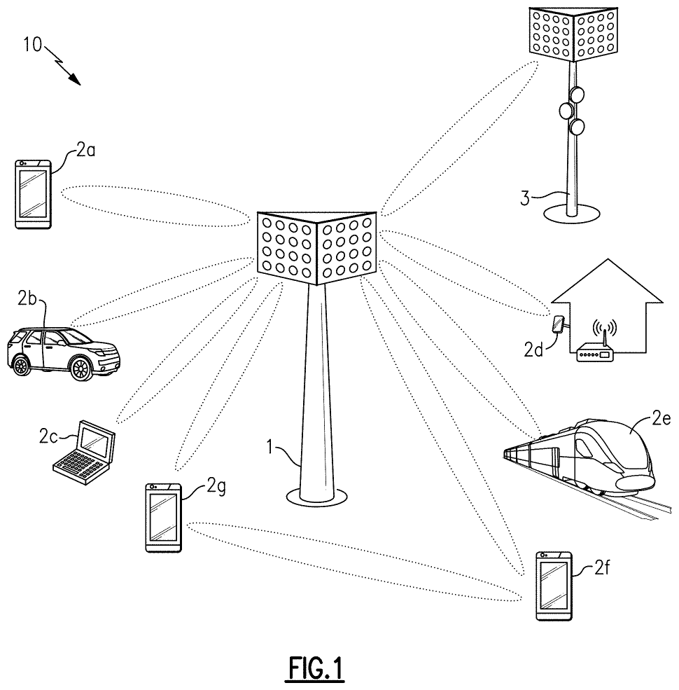

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul (for instance, as between mobile device 2g and mobile device 2f).

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

### Phase Shifters for Communication Systems

Antenna arrays can be used to transmit and/or receive radio frequency (RF) signals in base stations, network access points, mobile phones, tablets, customer-premises equipment (CPE), laptops, computers, wearable electronics, and/or other communication devices. For example, communication devices that utilize millimeter wave carriers (for instance, 30 GHz to 300 GHz), centimeter wave carriers (for instance, 3 GHz to 30 GHz), and/or other carrier frequencies can employ an antenna array to provide beam formation and directivity for transmission and/or reception of signals.

In the context of signal transmission, the signals from the antenna elements of the antenna array combine using constructive and destructive interference to generate an aggregate transmit signal exhibiting beam-like qualities with more signal strength propagating in a given direction away from the antenna array. In the context of signal reception, more signal energy is received by the antenna array when the signal is arriving from a particular direction. Accordingly, an antenna array can also provide directivity for reception of signals.

A signal conditioning circuit can be used to condition a transmit signal for transmission via an antenna element of an antenna array and/or to condition a received signal from the antenna element. Such signal conditioning circuits can include a phase shifter for providing controllable phase adjustment to a signal associated with a particular antenna element. The signal conditioning circuits can further include other circuitry, such as a power amplifier for amplifying a signal for transmission and/or a low noise amplifier (LNA) for amplifying a received signal while introducing a relatively small amount of noise.

To provide flexibility for beamforming, it is desirable that available phase adjustment for phase shifting span a wide angular range, for instance, a full 360°. In certain applications, it is also desirable for the phase shifting to have a step size that is substantially uniform.

Apparatus and methods for phase shifting are provided herein. In certain embodiments, a phase shifter includes a group of positive phase shifting circuits, a group of negative phase shifting circuits, and a group of selection switches for controlling selection of the positive phase shifting circuits and the negative phase shifting circuits. The selection switches are formed on a semiconductor die, and are operable to connect one or more selected positive phase shifting circuits and/or one or more selected negative phase shifting circuits between an input terminal and an output terminal, thereby controlling an overall phase shift provided by the phase shifter.

When connected between the input terminal and the output terminal, each of the positive phase shifting circuits provides a positive phase shift to an RF signal propagating through the phase shifter. Additionally, when connected between the input terminal and the output terminal, each of the negative phase shifting circuits provides a negative phase shift to the RF signal. By choosing a particular combination of positive and negative phase shifting circuits, a desired phase shift through the phase shifter is achieved.

In certain implementations, the selected phase shifting circuits are cascaded between the input terminal and the output terminal such that the phase shift through the phase shifter corresponds to the sum of the phase shifts provided by each selected phase shifting circuit. Accordingly, in certain implementations the selected positive phase shifting circuits and/or selected negative phase shifting circuits are arranged in series between the input terminal and the output terminal to achieve the desired amount phase shift.

Thus, the semiconductor die serves as a single switching device for controlling on/off switching functionality for cascading the selected positive phase shifting circuits and/or the selected negative phase shifting circuits.

The phase shifting circuits can be formed in a wide variety of ways. In certain implementations, phase shifting circuit networks, such as inductor-capacitor (LC) networks serve as phase shifting circuits, with values of the inductors and capacitors chosen to achieve a particular phase shift desired for a given phase shifting circuit. Examples of LC networks include pi (π) networks and tee (T) networks.

The phase shifting circuits can be implemented on the semiconductor die or off chip. For example, there may be different implementation scenarios, which can be impacted by operating frequency of the phase shifter and/or implementation of the phase shifting circuits.

In certain implementations, the positive phase shifting circuits and the negative phase shifting circuits each provide different amounts of phase shifting. For example, the phase shifting circuits can be implemented with binary weighting to provide a wide phase shifting range using a relatively few number of phase shifting circuits. Although an example with binary weighting has been described, the teachings herein are applicable to phase shifting circuits using other weighting schemes.

In certain implementations, a control circuit is implemented on the semiconductor die with the selection switches, and serves to generate control signals used for turning on or off the switches to thereby choose a particular selection of the phase shifting circuits. Implementing the phase shifter in this manner reduces routing congestion by avoiding a need to route switch control signals around a module and/or system board. In certain implementations, the control circuit receives digital data for controlling the state of the selection switches. For example, the semiconductor die can receive the digital data from a transceiver or radio frequency integrated circuit (RFIC) over an interface or bus.

The amount of phase shift provided by the phase shifter is based on the selected combination of positive phase shifting circuits and/or negative phase shifting circuits connected between the input terminal and the output terminal. In certain implementations, the phase shifter further includes shunt switches operable to connect any unselected phase shifting circuits to ground or another suitable reference voltage. Implementing the phase shifter in this manner can provide a number of benefits, including, but not limited to, inhibiting an unselected phase shifting circuit from inadvertently radiating as an antenna and/or from generating electromagnetic fields that impact signaling performance.

The phase shifters herein can be used for phase shifting signals for beamforming in the context of signal transmission and/or signal reception. Thus, the phase shifters can used in combination with antenna arrays that only transmit signals, with antenna arrays that only receive signals, and with antenna arrays that both transmit signals and receive signals.

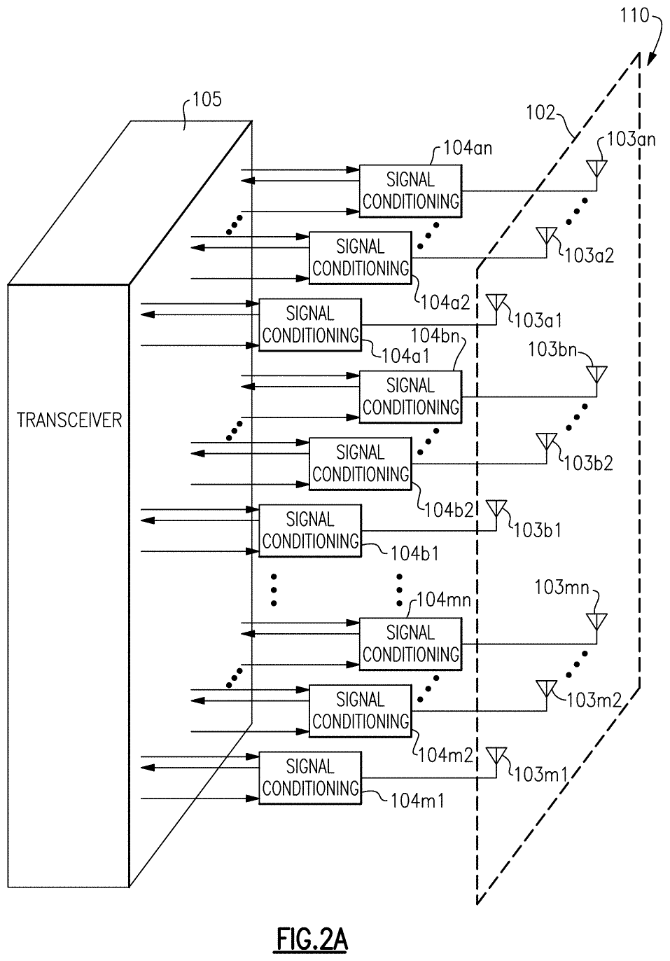

FIG. 2A is a schematic diagram of one embodiment of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers, centimeter wave carriers, and/or other frequency carriers can employ an antenna array such as the antenna array 102 to provide beam formation and directivity for transmission and/or reception of signals.

For example, in the illustrated embodiment, the communication system 110 includes an array 102 of m×n antenna elements, each of which are coupled to a separate signal conditioning circuit, in this embodiment. As indicated by the ellipses, the communication system 110 can be implemented with any suitable number of antenna elements and signal conditioning circuits.

With respect to signal transmission, the signal conditioning circuits 104a1, 104a2 . . . 104an, 104b1, 104b2 . . . 104bn, 104m1, 104m2 . . . 104mn can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits 104a1, 104a2 . . . 104an, 104b1, 104b2 . . . 104bn, 104m1, 104m2 . . . 104mn process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal is able to propagate for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits 104a1, 104a2 . . . 104an, 104b1, 104b2 . . . 104bn, 104m1, 104m2 . . . 104mn and processes signals received from the signal conditioning circuits.

As shown in FIG. 2A, the transceiver 105 generates control signals for the signal conditioning circuits 104a1, 104a2 . . . 104an, 104b1, 104b2 . . . 104bn, 104m1, 104m2 . . . 104mn. The control signals can be used for a variety of functions, such as controlling the gain and phase of transmitted and/or received signals to control beamforming. For example, each of the signal conditioning circuits 104a1, 104a2 . . . 104an, 104b1, 104b2 . . . 104bn, 104m1, 104m2 . . . 104mn can include a phase shifter implemented in accordance with the teachings herein.

FIG. 2B is a schematic diagram of one embodiment of beamforming to provide a transmit beam. FIG. 2B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 2B illustrates one embodiment of a portion of the communication system 110 of FIG. 2A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b. The first phase shifter 130a and the second phase shifter 130b can be implemented in accordance with any of the embodiments herein.

Although one embodiment of signal conditioning circuits is shown, other implementations of signal conditioning circuits are possible. For instance, in one example, a signal conditioning circuit includes one or more band filters, duplexers, diplexers, and/or other components.

In the illustrated embodiment, the first antenna element 113a and the second antenna element 113b are separated by a distance d. Additionally, FIG. 2B has been annotated with an angle θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle θ can be achieved. For example, when the first phase shifter 130a has a reference value of 0°, the second phase shifter 130b can be controlled to provide a phase shift of about −2πf(d/ν)cos θ radians, where f is the fundamental frequency of the transmit signal, d is the distance between the antenna elements, ν is the velocity of the radiated wave, and π is the mathematic constant pi.

In certain implementations, the distance d is implemented to be about ½ λ, where λ is the wavelength of the fundamental component of the transmit signal. In such implementations, the second phase shifter 130b can be controlled to provide a phase shift of about −πn cos θ radians to achieve a transmit beam angle θ.

Accordingly, a relative phase difference between the first phase shifter 130a and the second phase shifter 130b can be controlled to provide transmit beamforming. In certain implementations, a transceiver (for example, the transceiver 105 of FIG. 2A) controls phase values of one or more phase shifters to control beamforming.

FIG. 2C is a schematic diagram of one embodiment of beamforming to provide a receive beam. FIG. 2C is similar to FIG. 2B, except that FIG. 2C illustrates beamforming in the context of a receive beam rather than a transmit beam.

As shown in FIG. 2C, a relative phase difference between the first phase shifter 130a and the second phase shifter 130b can be selected to about equal to −2πf(d/ν)cos θ radians to achieve a desired receive beam angle θ. In implementations in which the distance d corresponds to about ½ λ, the phase difference can be selected to about equal to −πn cos θ radians to achieve a receive beam angle θ.

Although various equations for phase values to provide beamforming have been provided, other phase selection values are possible, such as phase values selected based on implementation of an antenna array, implementation of signal conditioning circuits, and/or a radio environment.

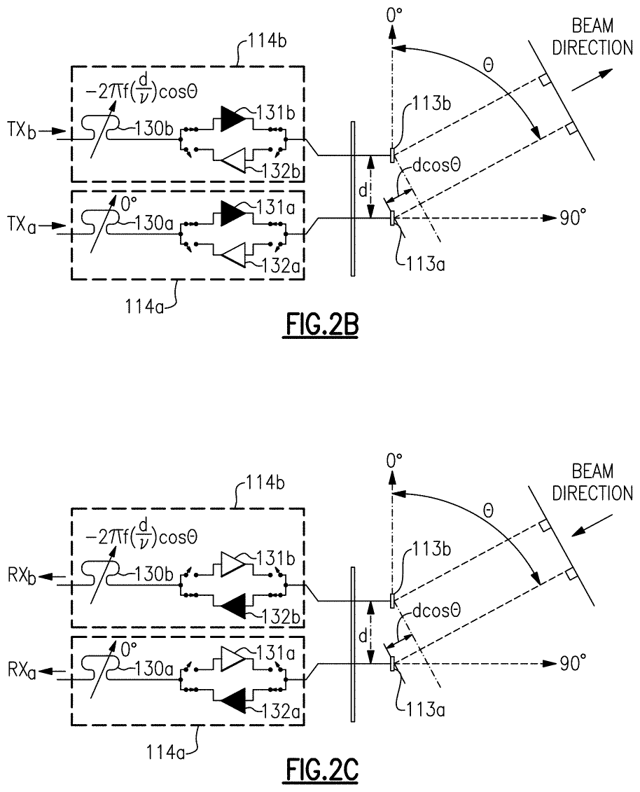

FIG. 3 is a schematic diagram of a phase shifter 230 according to one embodiment. The phase shifter 230 includes positive phase shifting circuits 201-203, negative phase shifting circuits 205-207, a first group of selection switches 211a-213b, a second group of selection switches 215a-217b, and joining paths 218-219. The phase shifter 230 further includes an input terminal (INPUT) for receiving an RF input signal and an output terminal (OUTPUT) for outputting an RF output signal having a desired phase shift with respect to the RF input signal.

In the illustrated embodiment, the first group of selection switches 211a-213b, the second group of selection switches 215a-217b, and the joining paths 218-219 are formed on a semiconductor die 200, while the positive phase shifting circuits 201-203 and the negative phase shifting circuits 205-207 are formed off chip, for instance, using surface mount components on a module substrate or system board. However, other implementations are possible, including, for example, implementations in which the positive phase shifting circuits 201-203 and the negative phase shifting circuits 205-207 are formed in all or part on the semiconductor die 200.

With continuing reference to FIG. 3, the positive phase shifting circuits 201-203 include a first positive phase shifting circuit 201, a second positive phase shifting circuit 202, and a third positive phase shifting circuit 203. Additionally, the negative phase shifting circuits 205-207 include a first negative phase shifting circuit 205, a second negative phase shifting circuit 206, and a third negative phase shifting circuit 207. Although an example with three pairs of positive and negative phase shifting circuits is depicted, a phase shifter can include more or fewer phase shifting circuits.

In the illustrated embodiment, the positive and negative phase shifting circuits have component values that are selected such that the positive and negative phase shifting circuits provide complementary phase shifts that are binary weighted. For example, the first positive phase shifting circuit 201 provides a phase shift of about +22.5°, while the first negative phase shifting circuit 205 provides a phase shift of about −22.5°. Additionally, the second positive phase shifting circuit 202 provides a phase shift of about +11.25°, while the second negative phase shifting circuit 206 provides a phase shift of about −11.25°. Furthermore, the third positive phase shifting circuit 203 provides a phase shift about +5.625°, while the third negative phase shifting circuit 207 provides a phase shift of about −5.625°.

Although one embodiment of phase shifting values has been provided, other implementations are possible. For example, phase shifting circuits need not be implemented with binary weights, but rather can have phase values implemented in accordance with any suitable weighting scheme. Additionally or alternatively, more or fewer phase shifting circuits can be included to achieve a desired granularity for phase adjustment.

In the illustrated embodiment, each of the positive phase shifting circuits 201-203 is selected by a corresponding pair of selection switches. For example, the first positive phase shifting circuit 201 is electrically connected between the selection switch 211a and the selection switch 211b. Additionally, the second positive phase shifting circuit 202 is electrically connected between the selection switch 212a and the selection switch 212b, and the third positive phase shifting circuit 203 is electrically connected between the selection switch 213a and the selection switch 213b. Thus, the selection switches 211a-213b can be selectively opened or closed to select a particular combination of the positive phase shifting circuits 201-203 for inclusion between the input terminal and the output terminal.

With continuing reference to FIG. 3, each of the negative phase shifting circuits 205-207 is selected by a corresponding pair of selection switches. For example, the first negative phase shifting circuit 205 is electrically connected between the selection switch 215a and the selection switch 215b. Additionally, the second negative phase shifting circuit 206 is electrically connected between the selection switch 216a and the selection switch 216b, and the third negative phase shifting circuit 207 is electrically connected between the selection switch 217a and the selection switch 217b. Thus, the selection switches 215a-217b can be selectively opened or closed to select a particular combination of the negative phase shifting circuits 205-207 for inclusion between the input terminal and the output terminal.

In the illustrated embodiment, the semiconductor die 200 also includes the joining paths 218-219 for cascading the selected phase shifting circuits.

The first group of selection switches 211a-213b, the second group of selection switches 215a-217b, and the joining paths 218-219 operate in combination with one another to route the RF signal from the input terminal to the output terminal along a path through a selection of phase shifting circuits that provide the desired phase shift.

For example, to provide the lowest amount of phase shift, each of the selection switches 211a-213b are opened, while each of the selection switches 215a-217b are closed to thereby select each of the negative phase shifting circuits 205-207 for inclusion along the RF signal path. Additionally, to provide the highest amount of phase shift, each of the selection switches 215a-217b are opened, while each of the selection switches 211a-213b are closed to thereby select each of the positive phase shifting circuits 205-207. Additionally, a mix of positive and negative phase shifting circuits can be selected to achieve various amounts of phase shift between the lowest amount of phase shift and the highest amount of phase shift.

With continuing reference to FIG. 3, as indicated by the arrows, when using the selection switches to select a particular positive or negative phase shifting circuit, the complementary phase shifting circuit is not selected. For example, when selecting the first positive phase shifting circuit 201, the selection switches 211a-211b are closed to select the first positive phase shifting circuit 201 while the selection switches 215a-215b are opened such that the first negative phase shifting circuit 205 is not selected.

In certain implementations, the semiconductor die 200 includes a control circuit 229 for controlling the state of the selection switches. The control circuit serves to generate control signals used for turning on or off the selection switches to thereby choose a particular selection of the positive phase shifting circuits 201-203 and/or the negative phase shifting circuit 205-207.

Implementing the phase shifter 230 in this manner reduces routing congestion by avoiding a need to route switch control signals around a module and/or system board. In certain implementations, the control circuit receives digital data for controlling the state of the selection switches. For example, the semiconductor die 200 can receive the digital data from a transceiver or RFIC over an interface.

To enhance integration, the semiconductor die 200 can further include additional circuitry, including, but not limited to, front end circuitry. Thus, the selection switches can be implemented on-chip with a wide range of other circuitry of a communication system to thereby provide a compact and/or low cost solution.

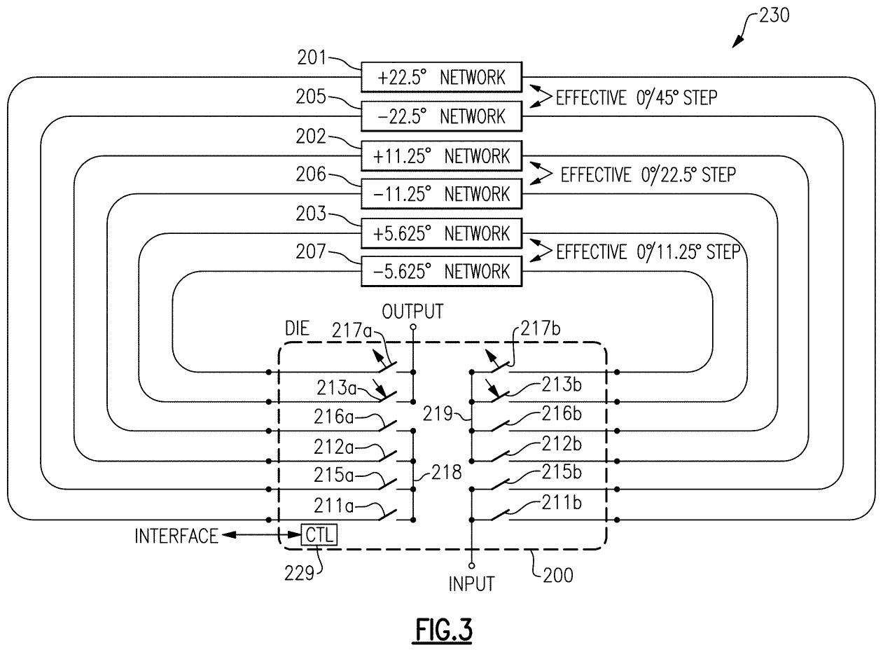

FIG. 4 is a schematic diagram of a phase shifter 250 according to another embodiment. The phase shifter 250 of FIG. 4 is similar to the phase shifter 230 of FIG. 4, except that the phase shifter 250 includes a semiconductor die 240 that further includes shunt switches for controlling the voltage of unselected phase shifting circuits

For example, as shown in FIG. 4, the semiconductor die 240 includes a pair of shunt switches 221a-221b for the first positive phase shifting circuit 201, a pair of shunt switches 222a-222b for the second positive phase shifting circuit 202, and a pair of shunt switches 223a-223b for the third positive phase shifting circuit 203. Additionally, the semiconductor die 240 further includes a pair of shunt switches 225a-225b for the first negative phase shifting circuit 205, a pair of shunt switches 226a-226b for the second negative phase shifting circuit 206, and a pair of shunt switches 227a-227b for the third negative phase shifting circuit 207. In this example, each pair of shunt switches connects an input and an output of a corresponding phase shifting circuit to ground.

With continuing reference to FIG. 4, as indicated by the arrows, when selecting a particular phase shifting circuit, the corresponding selection switches are closed while the corresponding pair of shunt switches are opened. For example, when selecting the first positive phase shifting circuit 201, the selection switches 211a-211b are closed while the shunt switches 221a-221b are opened. Additionally, when a particular phase shifting circuit is not selected, the corresponding selection switches are opened while the corresponding pair of shunt switches are closed. For example, when the first positive phase shifting circuit 201 is unselected, the selection switches 211a-211b are opened while the shunt switches 221a-221b are closed.

Implementing a phase shifter with shunt switches for electrically connecting unselected phase shifting circuits to ground or another suitable reference voltage provides a number of advantages. For example, implementing the phase shifter in this manner inhibits an unselected phase shifting circuit from inadvertently radiating as an antenna and/or from generating electromagnetic fields.

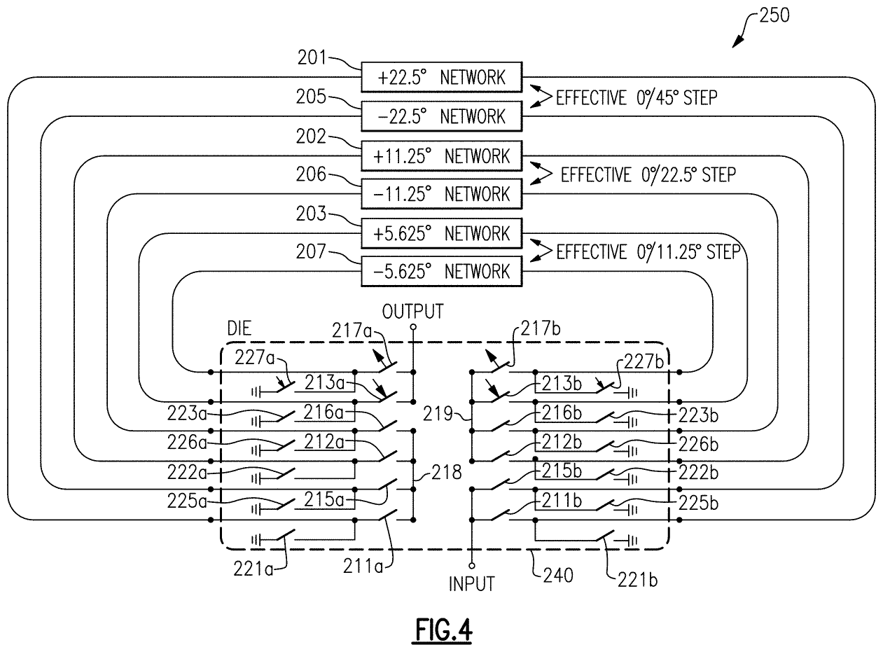

FIG. 5 is a schematic diagram of a phase shifter 300 according to another embodiment. The phase shifter 300 of FIG. 5 is similar to the phase shifter 250 of FIG. 4, except that the phase shifter 300 includes a semiconductor die 290 in which the positive phase shifting circuits 201-203 and the negative phase shifting circuits 205-207 are implemented thereon. Thus, the positive and negative phase shifting circuits are implemented on-chip with the switches, in this embodiment.

The phase shifters herein can include phase shifting circuits implemented on the semiconductor die or off chip.

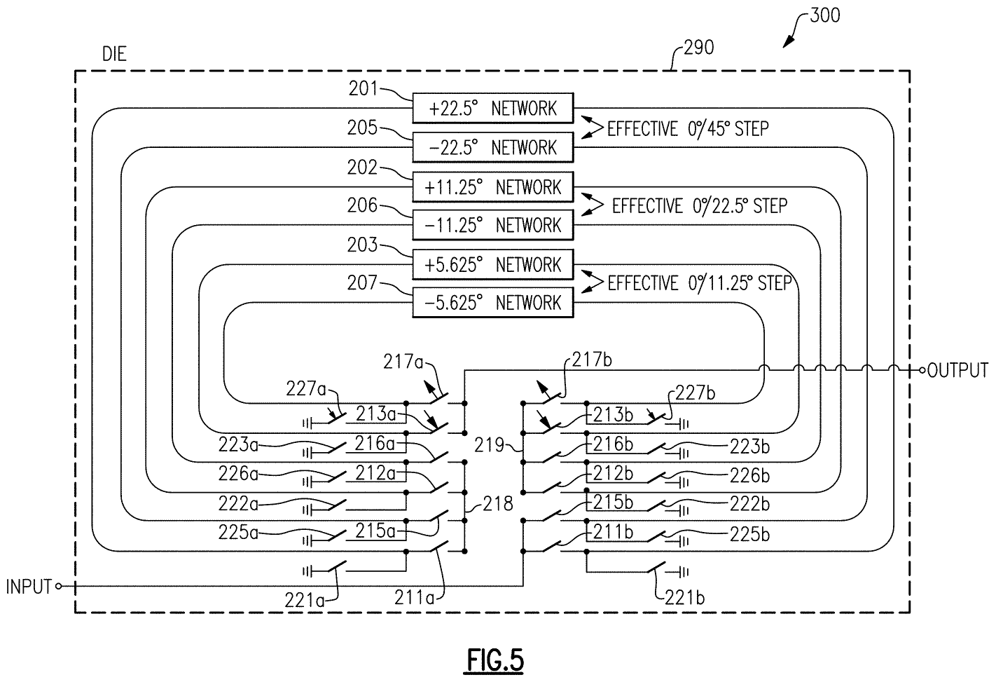

FIG. 6A is a schematic diagram of a pair of phase shifting networks 340 according to one embodiment. The pair of phase shifting networks 340 includes a positive phase shifting circuit 301, a negative phase shifting circuit 305, a first pair of selection switches 311a-311b, and a second pair of selection switches 315a-315b.

The first pair of selection switches 311a-311b operate to select the positive phase shifting circuit 301 for inclusion between an input (IN) and an output (OUT). Additionally, the second pair of selection switches 315a-315b operate to select the negative phase shifting circuit 305 for inclusion between the input and the output.

In the illustrated embodiment, the positive phase shifting circuit 301 includes a first series capacitor 321, a shunt inductor 323, and a second series capacitor 322. The positive phase shifting circuit 301 is implemented as a high-pass filter (HPF) in a T configuration.

With continuing reference to FIG. 6A, the negative phase shifting circuit 305 includes a first series inductor 331, a shunt capacitor 333, and a second series inductor 332. The negative phase shifting circuit 305 is implemented as a low-pass filter (LPF) in a T configuration.

In the illustrated embodiment, complementary circuit topologies are used to implement the positive phase shifting circuit and the negative phase shifting circuit. Implementing the phase shifting circuits in this manner aids in matching variation in phase shift versus frequency, thereby achieving a wideband phase shifter that operates with robust performance over a wide range of frequency.

Although one embodiment of a positive phase shifting circuit and a negative phase shifting circuit is depicted, the teachings herein are applicable to phase shifting circuits implemented in a wide variety of ways. Accordingly, other implementations are possible.

FIG. 6B is a graph of one example of phase versus frequency for the pair of phase shifting networks of FIG. 6A. The graph includes a first plot 341 of phase versus frequency for one implementation of the positive phase shifting circuit 301 of FIG. 6A, and a second plot 345 of phase versus frequency for one implementation of the negative phase shifting circuit 305 of FIG. 6A.

As shown in FIG. 6B, the positive phase shifting circuit and the negative phase shifting circuit have phase shift variation versus frequency that is similar to one another. When included in a phase shifter, the phase shifter operates with a relative phase slope across the band that is substantially flat. Thus, the phase shifter can achieve wideband operation with relatively constant phase shift and/or relatively uniform step size over a wide range of frequency.

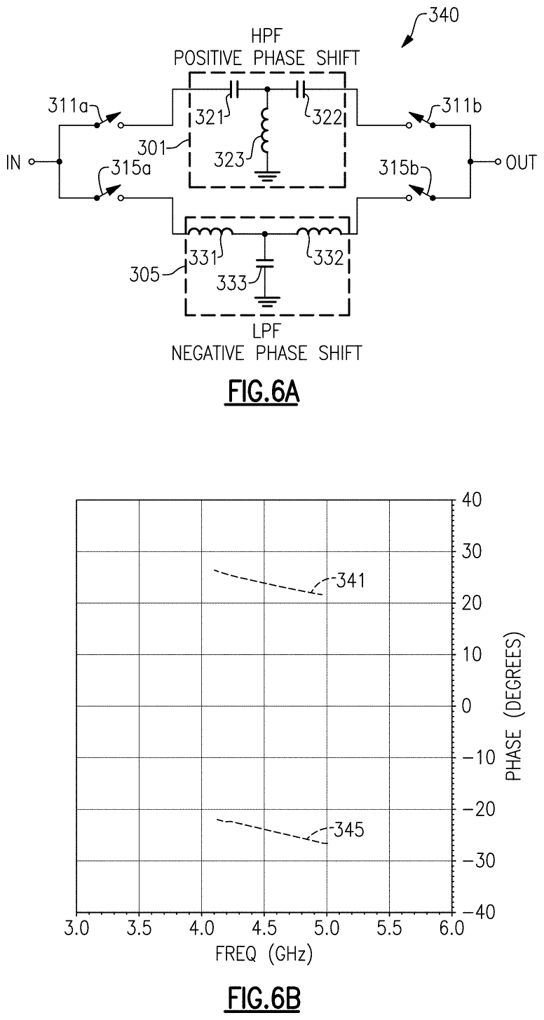

FIG. 7 is a schematic diagram of a pair of phase shifting networks 380 according to another embodiment. The pair of phase shifting network 380 includes a positive phase shifting circuit 351, a negative phase shifting circuit 355, a first pair of selection switches 311a-311b, and a second pair of selection switches 315a-315b.

The pair of phase shifting networks 380 of FIG. 7 is similar to the pair of phase shifting networks 340 of FIG. 6A, except that the pair of phase shifting networks 380 includes phase shifting circuits implemented in a π configuration rather than a T configuration.

For example, the positive phase shifting circuit 351 includes a first shunt inductor 361, a first series capacitor 363, a second shunt inductor 362, and is implemented as a HPF in a π configuration. Additionally, the negative phase shifting circuit 355 includes a first shunt capacitor 371, a series inductor 373, and a second shunt capacitor 372, and is implemented as a LPF in a π configuration.

Although FIG. 7 illustrates another embodiment of phase shifting circuits, the teachings herein are applicable to phase shifting circuits implemented in a wide variety of ways.

In certain implementations herein, component values of a phase shifting network may have values that are impractical to achieve certain phase shifts for a particular circuit network topology. For example, when using three pole LC π or T filters, the values for inductance or capacitance for a particular phase shift may be impractical. In certain implementations, the phase shifting network for realizing that phase shift can be implemented with a different topology, for instance, a one pole LC filter, a single series capacitor, a single shunt capacitor, a single series inductor, or a single shunt inductor, thereby achieving compact layout.

Accordingly, in certain implementations herein, phase shift circuits with different phase shifts can have a different number of poles and/or circuit components relative to one another.

Table 1 below shows example components values for a 50 Ohm high pass Pi (π) network for an operating frequency of 4.5 GHz. In this example, inductance values of less than 0.2 nH and greater than 5 nH are italicized. Additionally, capacitance values of less than 0.1 pF and greater than 5 pF are italicized. In certain implementations, italicized components are omitted when implementing the phase shifting networks in favor of implementing the phase shift using a circuit network of fewer components.

TABLE 1

| | Phase | Phase | | | |
|---|---|---|---|---|---|
| | Shift | Shift | L_{SHUNT} | C_{SERIES} | L_{SHUNT} |
| Stage | (Degrees) | (Rad) | (nH) | (pF) | (nH) |
| 1 | +48.000 | +0.838 | 3.97 | 0.9518 | 3.97 |
| 2 | +24.000 | +0.419 | 8.32 | 1.7391 | 8.32 |
| 3 | +12.000 | +0.209 | 16.83 | 3.4022 | 16.83 |
| 4 | +6.000 | +0.105 | 33.74 | 6.7671 | 33.74 |
| 5 | +3.000 | +0.052 | 67.53 | 13.5157 | 67.53 |

Table 2 below shows example components values for a 50 Ohm low pass Pi network for an operating frequency of 4.5 GHz. In this example, inductance values of less than 0.2 nH and greater than 5 nH are italicized. Additionally, capacitance values of less than 0.1 pF and greater than 5 pF are italicized. In certain implementations, italicized components are omitted when implementing the phase shifting networks in favor of implementing the phase shift using a circuit network of fewer components.

TABLE 2

| | Phase | Phase | | | |
|---|---|---|---|---|---|
| | Shift | Shift | C_{SHUNT} | L_{SERIES} | C_{SHUNT} |
| Stage | (Degrees) | (Rad) | (pF) | (nH) | (pF) |
| 1 | −48.000 | −0.838 | 0.3149 | 1.3142 | 0.3149 |
| 2 | −24.000 | −0.419 | 0.1504 | 0.7193 | 0.1504 |
| 3 | −12.000 | −0.209 | 0.0743 | 0.3677 | 0.0743 |
| 4 | −6.000 | −0.105 | 0.0371 | 0.1848 | 0.0371 |
| 5 | −3.000 | −0.052 | 0.0185 | 0.0926 | 0.0185 |

Table 3 below shows example components values for a 50 Ohm high pass Tee (T) network for an operating frequency of 4.5 GHz. In this example, inductance values of less than 0.2 nH and greater than 5 nH are italicized. Additionally, capacitance values of less than 0.1 pF and greater than 5 pF are italicized. In certain implementations, italicized components are omitted when implementing the phase shifting networks in favor of implementing the phase shift using a circuit network of fewer components.

TABLE 3

| | Phase | Phase | | | |
|---|---|---|---|---|---|
| | Shift | Shift | C_{SERIES} | L_{SHUNT} | C_{SERIES} |
| Stage | (Degrees) | (Rad) | (pF) | (nH) | (pF) |
| 1 | +48.000 | +0.838 | 1.5887 | 2.3796 | 1.5887 |
| 2 | +24.000 | +0.419 | 3.3278 | 4.3477 | 3.3278 |
| 3 | +12.000 | +0.209 | 6.7300 | 8.5055 | 6.7300 |
| 4 | +6.000 | +0.105 | 13.4971 | 16.9178 | 13.4971 |
| 5 | +3.000 | +0.052 | 27.0128 | 33.7892 | 27.0128 |

Table 4 below shows example components values for a 50 Ohm low pass Tee network for an operating frequency of 4.5 GHz. In this example, inductance values of less than 0.2 nH and greater than 5 nH are italicized. Additionally, capacitance values of less than 0.1 pF and greater than 5 pF are italicized. In certain implementations, italicized components are omitted when implementing the phase shifting networks in favor of implementing the phase shift using a circuit network of fewer components.

TABLE 4

| | Phase | Phase | | | |
|---|---|---|---|---|---|
| | Shift | Shift | L_{SERIES} | C_{SHUNT} | L_{SERIES} |
| Stage | (Degrees) | (Rad) | (nH) | (pF) | (nH) |
| 1 | −48.000 | −0.838 | 0.7873 | 0.5257 | 0.7873 |
| 2 | −24.000 | −0.419 | 0.3759 | 0.2877 | 0.3759 |
| 3 | −12.000 | −0.209 | 0.1859 | 0.1471 | 0.1859 |
| 4 | −6.000 | −0.105 | 0.0927 | 0.0739 | 0.0927 |
| 5 | −3.000 | −0.052 | 0.0463 | 0.0370 | 0.0463 |

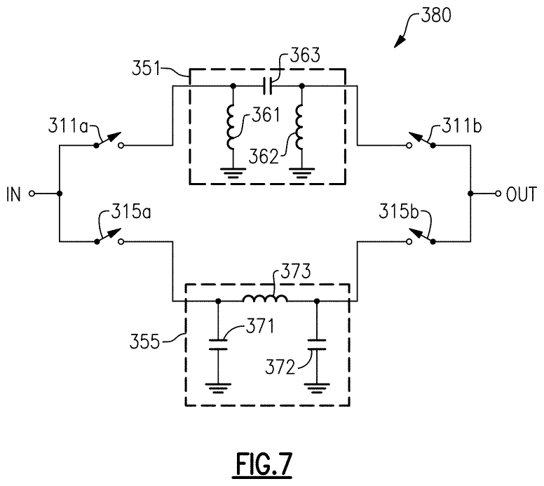

FIG. 8 is a schematic diagram of one embodiment of a mobile device 800. The mobile device 800 includes a baseband system 801, a transceiver 802, a front end system 803, antennas 804, a power management system 805, a memory 806, a user interface 807, and a battery 808.

The mobile device 800 can be used communicate using a wide variety of communications technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 8 as the transceiver 802. In one example, separate components (for instance, separate circuits or dies) can be provided for handling certain types of RF signals.

The front end system 803 aids is conditioning signals transmitted to and/or received from the antennas 804. In the illustrated embodiment, the front end system 803 includes phase shifters 810, power amplifiers (PAs) 811, low noise amplifiers (LNAs) 812, filters 813, switches 814, and duplexers 815. However, other implementations are possible.

For example, the front end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

The mobile device 800 operates with beamforming. For example, the front end system 803 includes phase shifters 810 having variable phase controlled by the transceiver 802. In certain implementations, the transceiver 802 controls the phase of the phase shifters 810 based on data received from the processor 801.

The phase shifters 810 are controlled to provide beam formation and directivity for transmission and/or reception of signals using the antennas 804. For example, in the context of signal transmission, the phases of the transmit signals provided to an antenna array used for transmission are controlled such that radiated signals combine using constructive and destructive interference to generate an aggregate transmit signal exhibiting beam-like qualities with more signal strength propagating in a given direction. In the context of signal reception, the phases are controlled such that more signal energy is received when the signal is arriving to the antenna array from a particular direction.

The phase shifters 810 can be implemented in accordance with any of the embodiments herein. Although FIG. 8 illustrates one example of a mobile device that can include phase shifters implemented in accordance with the teachings herein, the phase shifters herein can be used in communication systems implemented in a wide variety of ways. Accordingly, other implementations are possible.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 8, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 8, the power management system 805 receives a battery voltage from the battery 808. The battery 808 can be any suitable battery for use in the mobile device 800, including, for example, a lithium-ion battery.

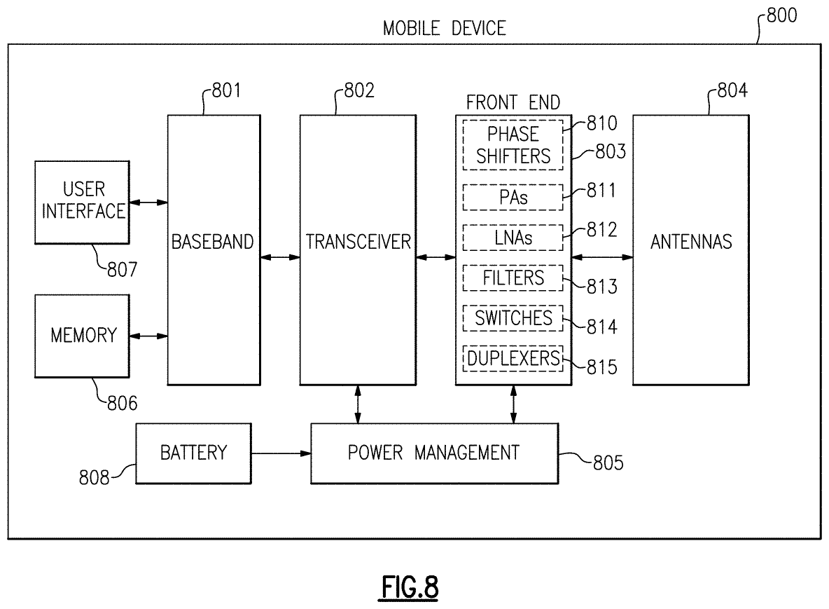

FIG. 9 is a plan view of one embodiment of a module 680. The module 680 includes a substrate 690 as well as various structures formed on and/or attached to the substrate 690. For example, the module 680 includes antenna array(s) 681, phase shifting circuits 682, encapsulation 683, IC(s) 684 (including a control circuit 691 and switches 692, in this embodiment), surface mount device(s) or SMD(s) 685, integrated passive device(s) or IPD(s) 686, and shielding 687. The module 680 illustrates various examples of components and structures that can be included in a module of a communication device that includes one or more phase shifters implemented in accordance with the teachings herein.

Although one example of a combination of components and structures is shown, a module can include more or fewer components and/or structures.

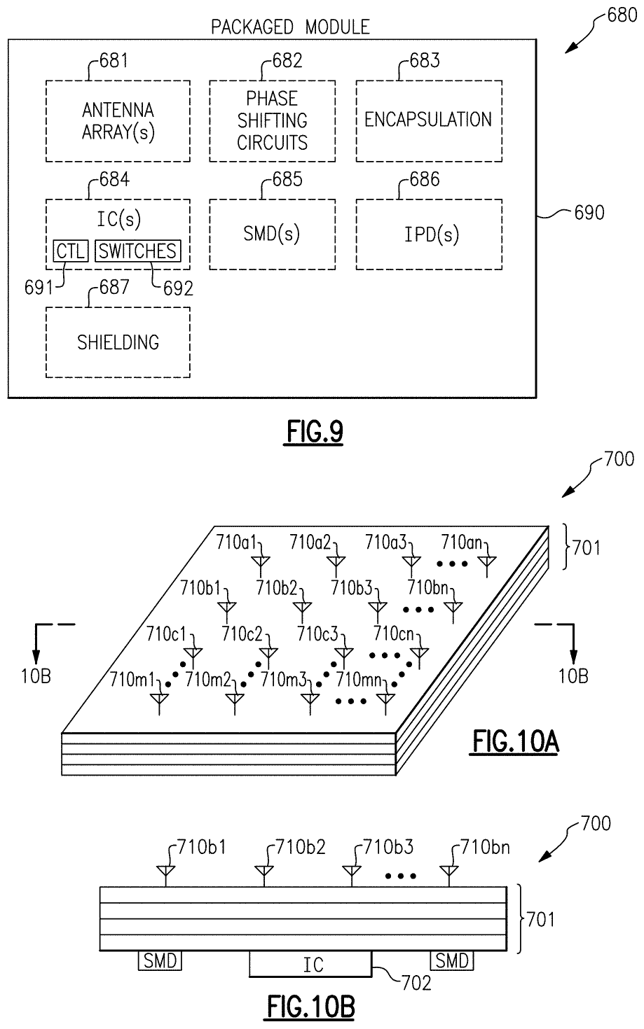

FIG. 10A is a perspective view of another embodiment of a module 700. FIG. 10B is a cross-section of the module 700 of FIG. 10A taken along the lines 10B-10B.

The module 700 includes a laminated substrate or laminate 701, a semiconductor die or IC 702 (not visible in FIG. 10A), SMDs (not visible in FIG. 10A), and an antenna array including antenna elements 710a1, 710a2, 710a3 . . . 710an, 710b1, 710b2, 710b3 . . . 710bn, 710c1, 710c2, 710c3 . . . 710cn, 710m1, 710m2, 710m3 . . . 710mn.

Although not shown in FIGS. 10A and 10B, the module 700 can include additional structures and components that have been omitted from the figures for clarity. Moreover, the module 700 can be modified or adapted in a wide variety of ways as desired for a particular application and/or implementation.

The antenna elements antenna elements 710a1, 710a2, 710a3 . . . 710 an, 710b1, 710b2, 710b3 . . . 710bn, 710c1, 710c2, 710c3 . . . 710cn, 710m1, 710m2, 710m3 . . . 710mn are formed on a first surface of the laminate 701, and can be used to receive and/or transmit signals, based on implementation. Although a 4×4 array of antenna elements is shown, more or fewer antenna elements are possible as indicated by ellipses. Moreover, antenna elements can be arrayed in other patterns or configurations, including, for instance, arrays using non-uniform arrangements of antenna elements. Furthermore, in another embodiment, multiple antenna arrays are provided, such as separate antenna arrays for transmit and receive.

In the illustrated embodiment, the IC 702 is on a second surface of the laminate 701 opposite the first surface. However, other implementations are possible. In one example, the IC 702 is integrated internally to the laminate 701.

In certain implementations, the IC 702 includes signal conditioning circuits associated with the antenna elements 710a1, 710a2, 710a3 . . . 710 an, 710b1, 710b2, 710b3 . . . 710bn, 710c1, 710c2, 710c3 . . . 710cn, 710m1, 710m2, 710m3 . . . 710mn and that include phase shifters implemented in accordance with the teachings herein. Although an implementation with one semiconductor chip is shown, the teachings herein are applicable to implementations with additional chips.

The laminate 701 can include various structures including, for example, conductive layers, dielectric layers, and/or solder masks. The number of layers, layer thicknesses, and materials used to form the layers can be selected based on a wide variety of factors, and can vary with application and/or implementation. The laminate 701 can include vias for providing electrical connections to signal feeds and/or ground feeds of the antenna elements. For example, in certain implementations, vias can aid in providing electrical connections between signal conditioning circuits of the IC 702 and corresponding antenna elements.

The antenna elements 710a1, 710a2, 710a3 . . . 710 an, 710b1, 710b2, 710b3 . . . 710bn, 710c1, 710c2, 710c3 . . . 710cn, 710m1, 710m2, 710m3 . . . 710mn can correspond to antenna elements implemented in a wide variety of ways. In one example, the array of antenna elements includes patch antenna element formed from a patterned conductive layer on the first side of the laminate 701, with a ground plane formed using a conductive layer on opposing side of the laminate 701 or internal to the laminate 701. Other examples of antenna elements include, but are not limited to, dipole antenna elements, ceramic resonators, stamped metal antennas, and/or laser direct structuring antennas.

### Applications

The principles and advantages of the embodiments described herein can be used for a wide variety of applications.

For example, phase shifters can be included in various electronic devices, including, but not limited to consumer electronic products, parts of the consumer electronic products, electronic test equipment, etc. Example electronic devices include, but are not limited to, a base station, a wireless network access point, a mobile phone (for instance, a smartphone), a tablet, a television, a computer monitor, a computer, a hand-held computer, a personal digital assistant (PDA), a microwave, a refrigerator, an automobile, a stereo system, a disc player, a digital camera, a portable memory chip, a washer, a dryer, a copier, a facsimile machine, a scanner, a multi-functional peripheral device, a wrist watch, a clock, etc. Further, the electronic devices can include unfinished products.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A phase shifter comprising:
an input terminal configured to receive a radio frequency input signal;
an output terminal configured to provide a radio frequency output signal having a phase shift with respect to the radio frequency input signal;
a plurality of positive phase shifting circuits;
a plurality of negative phase shifting circuits; and
a plurality of selection switches formed on a semiconductor die and configured to couple one or more selected phase shifting circuits between the input terminal and the output terminal, the one or more selected phase shifting circuits chosen from at least one of the plurality of positive phase shifting circuits or the plurality of negative phase shifting circuits.

2. The phase shifter of claim 1 wherein each of the plurality of negative phase shifting circuits provides a phase shift of about equal magnitude but opposite polarity as a corresponding one of the plurality of positive phase shifting circuits.

3. The phase shifter of claim 1 further comprising a plurality shunt switches configured to electrically connect one or more unselected phase shifting circuit to a reference voltage, the one or more unselected phase shifting circuits chosen from at least one of the plurality of positive phase shifting circuits or the plurality of negative phase shifting circuits.

4. The phase shifter of claim 1 wherein the plurality of positive phase shifting circuits includes a first plurality of inductor-capacitor networks, and the plurality of negative phase shifting circuits includes a second plurality of inductor-capacitor networks.

5. The phase shifter of claim 4 wherein the first plurality of inductor-capacitor networks are each implemented as a high pass filter, and the second plurality of inductor-capacitor networks are each implemented as a low pass filter.

6. The phase shifter of claim 4 wherein the first plurality of inductor-capacitor networks and the second plurality of inductor-capacitor networks are each implemented in a tee configuration.

7. The phase shifter of claim 4 wherein the first plurality of inductor-capacitor networks and the second plurality of inductor-capacitor networks are each implemented in a pi configuration.

8. The phase shifter of claim 4 wherein the first plurality of inductor-capacitor networks includes a plurality of series inductors and a plurality of shunt capacitors, and the second plurality of inductor-capacitor networks includes a plurality of series capacitors and a plurality of shunt inductors.

9. The phase shifter of claim 4 wherein the first plurality of inductor-capacitor networks includes a plurality of series capacitors and a plurality of shunt inductors, and the second plurality of inductor-capacitor networks includes a plurality of series inductors and a plurality of shunt capacitors.

10. The phase shifter of claim 1 further comprising a control circuit formed on the semiconductor die and configured to control the plurality of selection switches.

11. The phase shifter of claim 1 wherein each of the plurality of positive phase shifting circuits provides a different amount of phase shift to the radio frequency input signal.

12. The phase shifter of claim 11 wherein the plurality of positive phase shifting circuits are binary weighted.

13. A wireless device comprising:
an antenna array including a plurality of antenna elements;
a plurality of signal conditioning circuits each operatively associated with a corresponding one of the plurality of antenna elements and including a phase shifter, the phase shifter including a plurality of positive phase shifting circuits, a plurality of negative phase shifting circuits, and a plurality of selection switches, the plurality of selection switches formed on a semiconductor die and configured to couple one or more selected phase shifting circuits between an input and an output of the phase shifter, the one or more selected phase shifting circuits chosen from at least one of the plurality of positive phase shifting circuits or the plurality of negative phase shifting circuits; and
a transceiver electrically coupled to the plurality of signal conditioning circuits.

14. The wireless device of claim 13 wherein each of the plurality of negative phase shifting circuits provides a phase shift of about equal magnitude but opposite polarity as a corresponding one of the plurality of positive phase shifting circuits.

15. The wireless device of claim 13 wherein the phase shifter further includes a plurality shunt switches configured to electrically connect one or more unselected phase shifting circuit to a reference voltage, the one or more unselected phase shifting circuits chosen from at least one of the plurality of positive phase shifting circuits or the plurality of negative phase shifting circuits.

16. The wireless device of claim 13 wherein the plurality of positive phase shifting circuits includes a first plurality of inductor-capacitor networks, and the plurality of negative phase shifting circuits includes a second plurality of inductor-capacitor networks.

17. A method of phase shifting in a communication system, the method comprising:
selecting one or more phase shifting circuits using a plurality of selection switches of a semiconductor die, the one or more selected phase shifting circuits chosen from a plurality of available phase shifting circuits that include a plurality of positive phase shifting circuits and a plurality of negative phase shifting circuits;
electrically connecting the one or more selected phase shifting circuits between an input terminal and an output terminal using the plurality of selection switches;
receiving a radio frequency input signal at the input terminal; and
generating a radio frequency output signal at the output terminal with a phase shift relative to the radio frequency input signal, the phase shift based on the one or more selected phase shifting circuits.

18. The method of claim 17 further comprising electrically connecting at least one unselected phase shifting circuit to a reference voltage, the at least one unselected phase shifting circuit chosen from the plurality of available phase shifting circuits.

19. The method of claim 17 further comprising providing a different amount of phase shift to the radio frequency input signal using each of the plurality of positive phase shifting circuits.

20. The method of claim 17 wherein each of the plurality of negative phase shifting circuits provides a phase shift of about equal magnitude but opposite polarity as a corresponding one of the plurality of positive phase shifting circuits.
